(19) United States
(12) Patent Application Publication
(10) Pub. No.: US 2026/0302544 A1
(43) Pub. Date: Oct. 1, 2026

(54) ELECTRONIC CIRCUIT UNIT AND BATTERY MODULE

(71) Applicant: Panasonic Intellectual Property Management Co., Ltd., Osaka (JP)

(72) Inventor: Yosuke SAWA, Hyogo (JP)

(21) Appl. No.: 19/392,677

(22) Filed: Nov. 18, 2025

Related U.S. Application Data
(63) Continuation of application No. PCT/JP2025/021091, filed on Jun. 11, 2025.

(30) Foreign Application Priority Data
Mar. 28, 2025 (JP) 2025-056121

(51) Int. Cl. H01M 50/519; H01M 50/503

(52) U.S. Cl. CPC H01M 50/519; H01M 50/503

(57) ABSTRACT

An electronic circuit unit comprising: a lower substrate having a surface including an upper face and a lower face along the horizontal plane; a heavy component (switching unit) supported on the upper face of the lower substrate and electrically connected to a wiring on the lower substrate; and a bus bar that is attached to the surface of the lower substrate, constitutes the wiring, and is disposed so as to overlap the heavy component in a plan view.

### CROSS REFERENCE TO RELATED APPLICATION

This is a continuation application claiming priority of International Patent Application No. PCT/JP2025/021091 with an international filing date of Jun. 11, 2025, which claims priority of Japanese Patent Application No. 2025-056121 filed on Mar. 28, 2025, the entire contents of which are incorporated herein by reference.

### BACKGROUND

### Technical Field

The present disclosure relates to an electronic circuit unit and a battery module.

### Background Art

JP H8-274421 A discloses an electronic circuit unit in which an electronic device is mounted on a substrate of an electronic circuit. The electronic device mounted on the substrate includes a power transistor that generates a large amount of heat. In the circuit connected to the power transistor, a large current needs to flow, and thus a bus bar is provided on the substrate.

### SUMMARY

Such an electronic circuit unit may be applied as a built-in device or an external device of a battery module. Since a heavy component such as an iron core or a copper coil is provided in an electronic circuit unit for a battery module, a substrate is required to have strength. In the electrical connection box described above, this point is not considered.

An object of the present disclosure is to improve strength of an electronic circuit unit provided with a heavy component.

A first aspect of the present disclosure provides an electronic circuit unit comprising: a substrate having a surface including an upper face and a lower face along the horizontal plane; a heavy component supported on the upper face of the substrate and electrically connected to a wiring on the substrate; and a bus bar that is attached to the surface of the substrate, constitutes the wiring, and is disposed so as to overlap the heavy component in a plan view.

A second aspect of the present disclosure provides a battery module comprising: the aforementioned electronic circuit unit; and a battery cell module connected to the electronic circuit unit.

According to the present disclosure, it is possible to improve strength of an electronic circuit unit provided with a heavy component.

### BRIEF DESCRIPTION OF THE DRAWINGS

FIG. 1 is a perspective view of a battery module according to an embodiment.

FIG. 2 is a schematic view of the battery module of FIG. 1.

FIG. 3 is a perspective view of the electronic circuit unit of FIG. 2 as viewed from above.

FIG. 4 is a perspective view of the electronic circuit unit of FIG. 2 as viewed from below.

FIG. 5 is an exploded perspective view of the electronic circuit unit of FIG. 2.

FIG. 6 is a perspective view of the bus bar of FIG. 4 as viewed from above.

FIG. 7 is a plan view of the electronic circuit unit of FIG. 3 in a state where an upper substrate is removed.

FIG. 8 is a side view of the electronic circuit unit of FIG. 3.

FIG. 9 is a perspective view of a bus bar according to a first modification.

FIG. 10 is a perspective view of a bus bar according to a second modification.

FIG. 11 is a perspective view of a bus bar according to a third modification.

FIG. 12 is a perspective view of a bus bar according to a fourth modification.

### DETAILED DESCRIPTION

Hereinafter, embodiments of the present invention are described with reference to the drawings. Note that the same or corresponding elements are denoted by the same reference numerals throughout the drawings, and overlapping of detailed description will be omitted.

An electronic circuit unit according to an embodiment of the present disclosure includes: a substrate having a surface including an upper face and a lower face along the horizontal plane; a heavy component supported on the upper face of the substrate and electrically connected to a wiring on the substrate; and a bus bar that is attached to the surface of the substrate, constitutes the wiring, and is disposed so as to overlap the heavy component in a plan view.

According to the above configuration, the bus bar is disposed so as to overlap the heavy component in plan view. A gravitational load acting on the substrate from a heavy component is received by the bus bar, and deformation of the substrate and deformation of the electronic circuit unit can be suppressed.

In an electronic circuit unit according to another embodiment of the present disclosure, the bus bar may include a substrate contact portion that is in surface contact with the surface of the substrate in a region overlapping the heavy component in plan view.

According to the above configuration, since the gravitational load easily flows to the bus bar in the substrate contact portion, the load shared by the substrates is easily reduced.

In an electronic circuit unit according to another embodiment of the present disclosure, the substrate contact portion may be provided with a conductive member electrically connected to the heavy component.

According to the above configuration, the substrate contact portion overlaps the heavy component in plan view and is in surface contact with the substrate. By providing the conductive member on such a substrate contact portion, a structure for electrically connecting the bus bar to the heavy component becomes compact.

In an electronic circuit unit according to another embodiment of the present disclosure, the conductive member may be a metal fastener that fixes the substrate contact portion to the substrate and to the heavy component.

According to the above configuration, when the substrate contact portion is mechanically fixed to the substrate, the bus bar is electrically connected to the heavy component. Thus, the assembly operation of the electronic circuit unit is simplified.

In an electronic circuit unit according to another embodiment of the present disclosure, the bus bar may extend along a longitudinal direction of the substrate.

According to the above configuration, under the influence of a gravitational load from a heavy component, there is a possibility that the substrate undergoes bending deformation such that the central portion in the longitudinal direction is directed downward with respect to both ends in the longitudinal direction. Since the bus bar extends along the longitudinal direction, such bending deformation is suppressed.

In an electronic circuit unit according to another embodiment of the present disclosure, a pair of end fixation points for fixing the bus bar to the substrate may be set at both ends of the bus bar.

According to the above configuration, the pair of end fixation points is disposed as far as possible along the longitudinal direction of the substrate. The bending deformation of the substrate is more easily suppressed.

In an electronic circuit unit according to another embodiment of the present disclosure, at least one of one end portion and the other end portion of the bus bar may protrude in the longitudinal direction with respect to the heavy component in plan view, and at least one of the pair of end fixation points may be disposed outside the heavy component in plan view.

According to the above configuration, since at least one of the pair of end fixation points is disposed outside the heavy component in plan view, bending deformation of the substrate is more easily suppressed.

An electronic circuit unit according to another embodiment of the present disclosure further includes a casing that supports the substrate, in which a unit fixation point for fixing the substrate to the casing may be set at a peripheral edge portion of the substrate, and at least one of the pair of end fixation points may be disposed between the heavy component and the unit fixation point in plan view.

According to the above configuration, since at least one of the pair of ends of the bus bar is fixed to the substrate between the heavy component and the unit fixation point, the bending deformation of the substrate is more easily suppressed.

In an electronic circuit unit according to another embodiment of the present disclosure, the bus bar may include a main portion extending in the longitudinal direction along the surface, and a rib protruding upward or downward from a peripheral edge of the main portion and extending in the longitudinal direction.

According to the above configuration, the bending deformation of the substrate is further suppressed by the presence of the rib extending in the longitudinal direction and the height direction.

In an electronic circuit unit according to another embodiment of the present disclosure, the bus bar may be attached to a lower face of the substrate.

According to the above configuration, it is easy to realize a configuration in which the bus bar overlaps the heavy component in plan view and a configuration in which the bus bar is brought into surface contact with the substrate in the overlap region.

A battery module according to an embodiment of the present disclosure includes: the aforementioned electronic circuit unit; and a battery cell module connected to the electronic circuit unit.

According to the above configuration, it is possible to provide a battery module capable of suppressing deformation of the substrate and the electronic circuit unit.

In a battery module according to another embodiment of the present disclosure, the electronic circuit unit may include, as the heavy component, a DC voltage conversion circuit that converts a DC voltage.

According to the above configuration, deformation of the substrate supporting the DC voltage conversion circuit can be suppressed.

Hereinafter, specific examples of the present disclosure will be described in detail with reference to the drawings. In the following description, terms (for example, “upper”, “lower”, and other terms including those terms.) indicating specific directions and positions are used as necessary, but the use of these terms is to facilitate understanding of the present disclosure with reference to the drawings, and the technical scope of the present disclosure is not limited by the meanings of these terms. Parts denoted by the same reference numerals in a plurality of drawings indicate the same or equivalent parts or members. Furthermore, the following embodiments illustrate specific examples of the technical idea of the present disclosure, and do not limit the present disclosure to the following. In addition, dimensions, materials, shapes, relative arrangements, and the like of the components described below are not intended to limit the scope of the present disclosure only to the dimensions, materials, shapes, relative arrangements, and the like unless otherwise specified, and are intended to be illustrative. The contents described in one embodiment and example are also applicable to other embodiments and examples. The sizes, positional relationships, and the like of the members illustrated in the drawings may be exaggerated for clarity of description.

The battery module of the present disclosure is applied to, for example, an emergency power supply such as a battery backup unit (BBU). However, the present disclosure does not specify the application of the battery module, and can be used as a power source for various other electric devices such as a power source of a traveling motor of a vehicle.

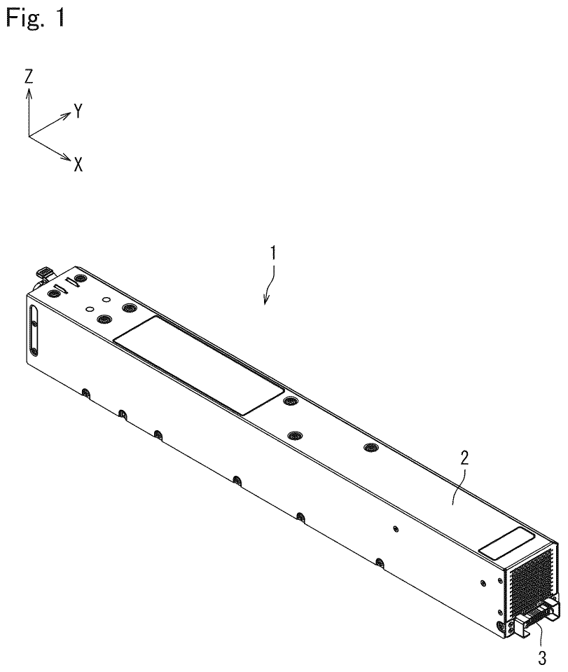

With reference to FIG. 1, battery module 1 includes casing 2. The casing 2 has a rectangular parallelepiped shape. A connector 3 is attached to an end surface of the casing 2. The connector 3 can be connected to an external power supply or an electric load.

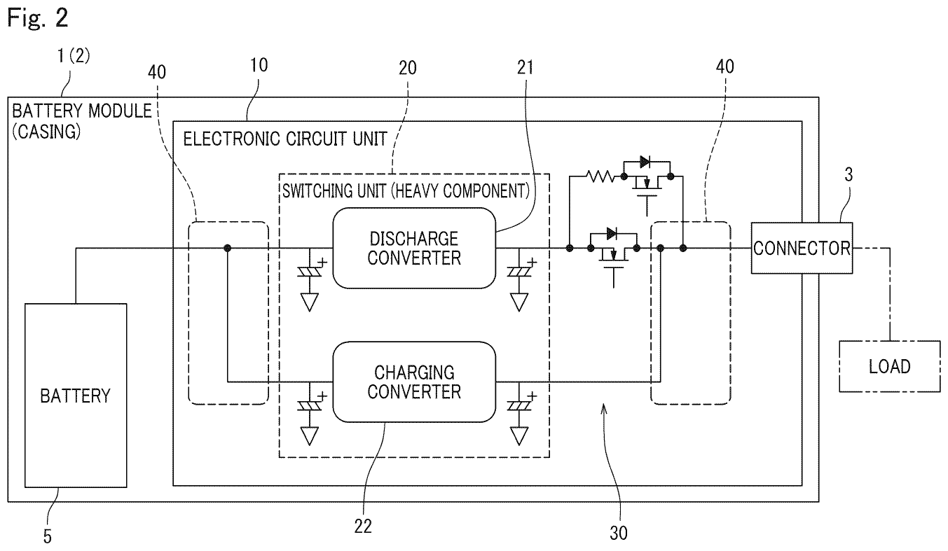

With reference to FIG. 2, the casing 2 accommodates the battery cell module 5 and the electronic circuit unit 10 of the battery module 1. The battery cell module 5 is a secondary battery that can be repeatedly charged and discharged, such as a lithium ion battery, a nickel hydrogen battery, or a lead storage battery, and stores DC power. When the external power supply is connected to the connector 3, the battery cell module 5 can be charged with power supplied from the external power supply. When the electric load is connected to the connector 3, the electric power discharged from the battery cell module 5 can be supplied to the electric load.

The electronic circuit unit 10 is spatially and electrically arranged between the connector 3 and the battery cell module 5. The electronic circuit unit 10 includes a switching unit 20 and a wiring 30. The wiring 30 connects the switching unit 20 to the connector 3 and the battery cell module 5. The switching unit 20 converts a voltage when power is supplied between the connector 3 (that is, an external power supply or an electric load) and the battery cell module 5. The “voltage conversion” includes not only step-down and step-up, but also conversion from AC to DC and vice versa. The switching unit 20 includes a discharge converter 21 that operates when the battery cell module 5 is discharged, and a charging converter 22 that operates when the battery cell module 5 is charged.

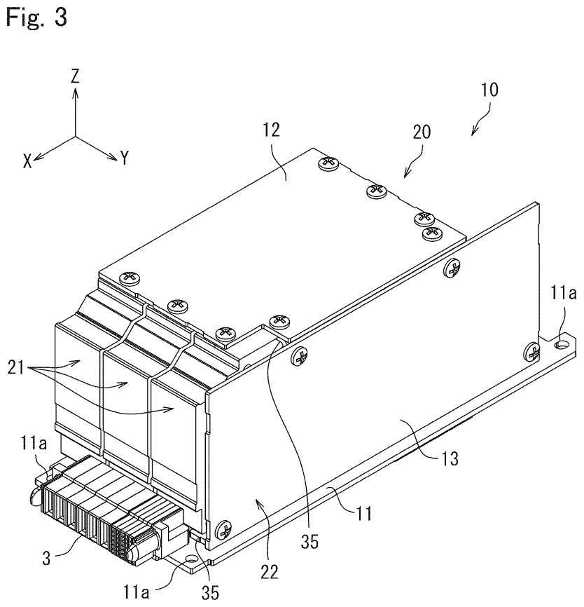

With reference to FIGS. 3 to 5, the electronic circuit unit 10 includes a plurality of substrates. A large part of the wiring 30 is realized by a conductive material pattern printed on the surface of the substrate. A part of the wiring 30 includes a plurality of tabs 35 and bus bars 40 attached to the substrate.

As a mere example, the plurality of substrates include the lower substrate 11, the upper substrate 12, and one or more charge/discharge substrates 13 (as an example, one for charging and three for discharging). Each substrate is made of a synthetic resin material and has a flat plate shape. The lower substrate 11 and the upper substrate 12 are arranged in a horizontal posture. Surfaces of the lower substrate 11 and the upper substrate 12 include an upper face and a lower face along the horizontal plane. The lower substrate 11 has a substantially rectangular shape in plan view. Hereinafter, a long side direction of the rectangle is referred to as a “longitudinal direction X”, a short side direction is referred to as a “width direction Y”, and a direction (vertical direction) orthogonal to both the longitudinal direction X and the width direction Y is referred to as a “height direction Z”. The charge/discharge substrate is sandwiched between the lower substrate 11 and the upper substrate 12. The switching unit 20 (in particular, the discharge converter 21) is a heavy component including an iron core and a copper coil, is supported on the upper face of the lower substrate 11, and is electrically connected to the wiring 30 on the lower substrate 11.

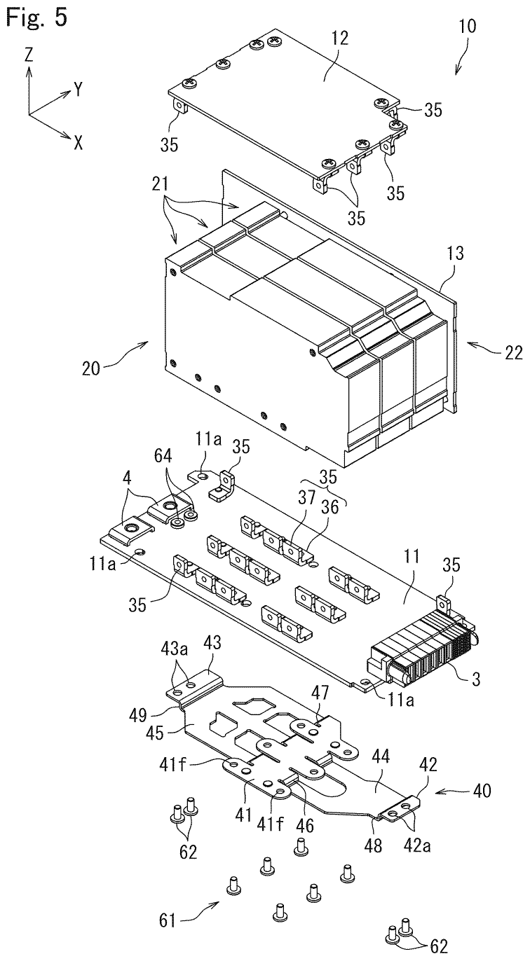

With reference to FIG. 5, the connector 3 and the terminal block 4 are provided on the upper face of the lower substrate 11. The connector 3 is disposed at an end on one side in the longitudinal direction, and is partially exposed to the outside of the casing 2 when the electronic circuit unit 10 is accommodated in the casing 2. The terminal block 4 is disposed at the other end in the longitudinal direction. The wiring on the lower substrate 11 is connected to the battery cell module 5 via a cable (not shown) connected to the terminal block 4.

The tab 35 is made of a material having conductivity, for example, a metal material such as a copper alloy, stainless steel, or an aluminum alloy. The tab 35 is manufactured by pressing a plate material of such a material and has an L shape. The tab 35 includes a horizontal portion 36 overlapped with the upper face of the lower substrate 11, and a vertical portion 37 bent at the peripheral edge of the horizontal portion 36 and overlapped with the surface of the charge/discharge substrate. The tab 35 is attached to the lower substrate 11 in a posture in which the vertical portion 37 extends in the longitudinal direction X and the height direction Z, that is, in a posture in which the vertical portion 37 extends parallel to the charge/discharge substrate. For attachment of the tab 35, for example, a bolt is used. In this case, a bolt is inserted into the lower substrate 11 upward, and is screwed into a female screw provided on the tab 35. A bolt is inserted from the side of the charge/discharge substrate and screwed into a female screw provided on the tab 35. As a result, the wiring pattern printed on the lower substrate 11 is electrically connected to the wiring pattern printed on the charge/discharge substrate via the tab 35. The plurality of tabs 35 are similarly attached to the upper substrate 12.

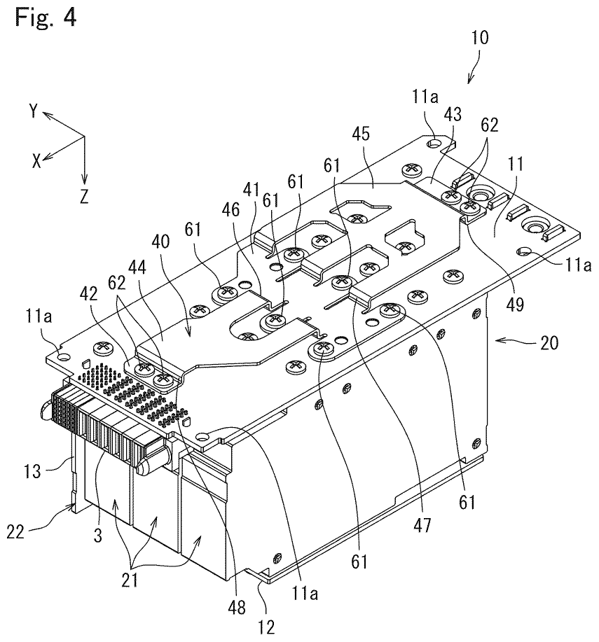

With reference to FIGS. 4 and 5, the bus bar 40 is attached to the surface of the substrate, in the present embodiment, the lower face of the lower substrate. The bus bar 40 is made of a conductive material, for example, a metal material such as a copper alloy, stainless steel, or an aluminum alloy. The bus bar 40 is manufactured by pressing a plate material of such a material.

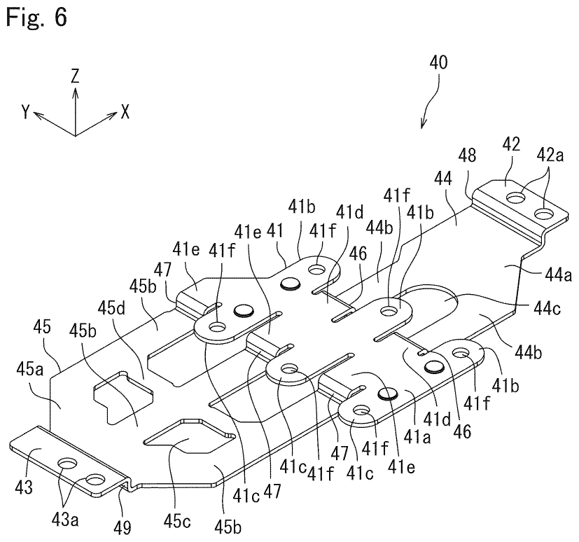

With reference to FIGS. 4 and 6, the bus bar 40 extends along the longitudinal direction X. The bus bar 40 includes a substrate contact portion 41, a pair of end contact portions (a first end contact portion 42 and a second end contact portion), a pair of connection portions (a first connection portion 44 and a second connection portion 45), a pair of central upright wall portions (a first central upright wall portion 46 and a second central upright wall portion 47), and a pair of end upright wall portions (a first end upright wall portion 48 and a second end upright wall portion 49).

The substrate contact portion 41, the pair of end contact portions 42 and 43, and the pair of connection portions 44 and 45 extend horizontally along the lower face of the lower substrate 11. The substrate contact portion 41 is located at the center in the longitudinal direction X, and the pair of end contact portions 42 and 43 is located at both ends in the longitudinal direction X. The first connection portion 44 is located between the substrate contact portion 41 and the first end contact portion 42 on one side in the longitudinal direction X, and the second connection portion 45 is located between the substrate contact portion 41 and the second end contact portion 43 on the other side in the longitudinal direction X. The substrate contact portion 41 and the pair of end contact portions 42 and 43 are positioned above the pair of connection portions 44 and 45 and are in surface contact with the lower face of the lower substrate 11. The pair of connection portions 44 and 45 is slightly separated downward from the lower face of the lower substrate 11.

The substrate contact portion 41 includes a central bus 41a extending in the width direction Y at the center in the longitudinal direction X, one or more first central terminals 41b and one or more first protrusions 41d protruding from the central bus 41a to one side in the longitudinal direction X, and one or more second central terminals 41c and one or more second protrusions 41e protruding from the central bus 41a to the other side in the longitudinal direction X.

In the present embodiment, as a mere example, the number of the first central terminals 41b and the second central terminals 41c is three, the number of the first protrusions is two, and the number of the second protrusions is three. The three first central terminals 41b and the two first protrusions 41d are alternately arranged in the width direction Y. The three second central terminals 41c and the two second protrusions 41e are alternately arranged in the width direction Y. The first central terminal 41b and the second central terminal 41c protrude in the longitudinal direction X more largely as viewed from the central bus 41a with respect to the first protrusion 41d and the second protrusion 41e.

When viewed from the central bus 41a, a set of the first central terminal 41b and the second central terminal 41c and a set of the first protrusion 41d and the second protrusion 41e are alternately arranged from one side to the other side in the width direction Y. In each set, two elements constituting the set are located at the same position in the width direction Y and protrude to opposite sides in the longitudinal direction X. At the end on the other side in the width direction Y, the second protrusion 41e alone protrudes from the central bus 41a without forming a set with the first protrusion 41d.

The first connection portion 44 has a first assembly portion 44a continuous with the first end contact portion 42 via the first end upright wall portion 48, and a plurality of first extension portions 44b extending separately from the first assembly portion 44a. The plurality of first extension portions 44b are arranged at intervals in the width direction Y and extend in parallel to each other in the longitudinal direction X. The first extension portion 44b is connected to the first assembly portion 44a on one side in the longitudinal direction X and is continuous to the first protrusion 41d of the substrate contact portion 41 via the first central upright wall portion 46 on the other side in the longitudinal direction X. The number of the first extension portions 44b is the same as that of the first protrusions 41d, and is two in this example. The first connection portion 44 has an opening 44c surrounded by the two first extension portions 44b and the first assembly portion 44a.

The second connection portion 45 has a second assembly portion 45a continuous with the second end contact portion 43 via the second end upright wall portion 49, and a plurality of second extension portions 45b extending separately from the second assembly portion 45a. The plurality of second extension portions 45b are arranged at intervals in the width direction Y and extend in parallel to each other in the longitudinal direction X. The second extension portion 45b is connected to the second assembly portion 45a on one side in the longitudinal direction X and is continuous to the second protrusion 41e of the substrate contact portion 41 via the second central upright wall portion 47 on the other side in the longitudinal direction X. The number of the second extension portions 45b is the same as that of the second protrusions 41e, and is three in this example. The second connection portion 45 further includes a bridge portion 45d that connects central portions of the three second extension portions 45b in the width direction Y. The second connection portion 45 has four openings 45c surrounded by the three second extension portions 45b, the bridge portion 45d, and the second assembly portion 45a.

One through hole 41f is provided in each of the first central terminal 41b and the second central terminal 41c of the substrate contact portion 41. Two through-holes 42a and two through-holes 43a are provided in each of the first end contact portion 42 and the second end contact portion 43.

With reference to FIG. 4, the bus bar 40 is fixed to the lower substrate 11 in a state where upper faces of the substrate contact portion 41, the first end contact portion 42, and the second end contact portion 43 are in surface contact with the lower face of the lower substrate 11. This surface contact causes each of the central terminals 41b and 41c of the substrate contact portion 41 to overlap the wiring pattern printed on the lower face of the lower substrate 11.

In the present embodiment, the bolts 61 and 62 are used for fixation. The bolt 61 is an example of a conductive member made of a conductive material such as stainless steel, and is an example of a fastener that fixes the substrate contact portion 41 to the lower substrate 11 and the switching unit 20. The bolt 62 is an example of a fastener for fixing the pair of end contact portions 42 and 43 to the lower substrate 11.

The bolt 62 is inserted through the through holes 42a and 43a of the end contact portions 42 and 43 from below upward, passes through the lower substrate 11, and is screwed into the nut 64 fixed to the upper face of the lower substrate 11. The through holes 42a and 43a and the bolt 62 and the nut 64 assembled thereto correspond to end fixation points set at both ends of the bus bar 40, and the bus bar 40 is fixed to the lower substrate 11 at the end fixation points.

The bolt 61 is inserted through the through hole 41f of each of the central terminals 41b and 41c upward from below, passes through the lower substrate 11, further passes through the horizontal portion 36 of the tab 35, and is screwed into a female screw provided on the tab 35. As a result, the wiring pattern on the lower face of the lower substrate 11 is conducted to the wiring pattern printed on the charge/discharge substrate of the switching unit 20 via the central terminals 41b and 41c, the bolt 61, and the tab 35. The through hole 41f and the bolt 61 assembled thereto correspond to a central fixation point set at the central portion in the longitudinal direction X of the bus bar 40, and the bus bar 40 is also fixed to the lower substrate 11 at the central fixation point.

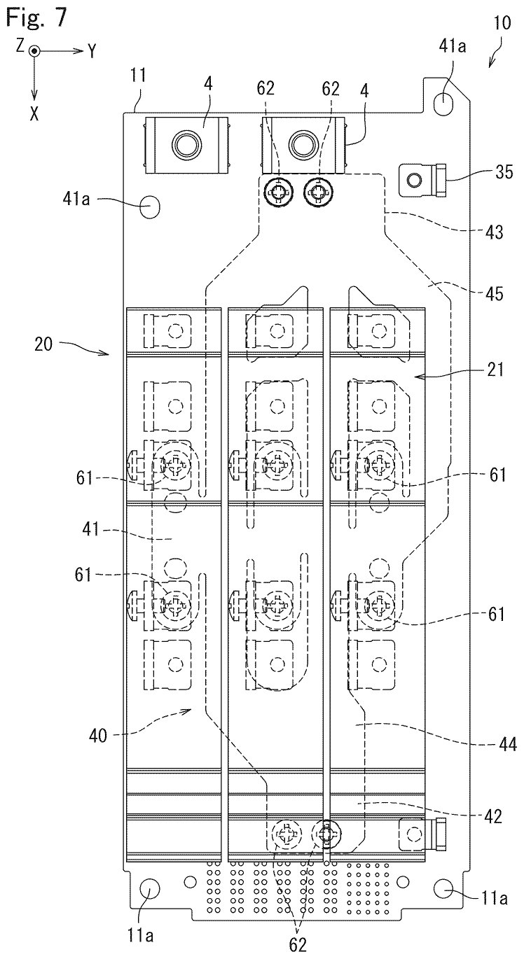

With reference to FIG. 7, the bus bar 40 is disposed so as to overlap with the switching unit 20 as a heavy component in plan view. The substrate contact portion 41 is in surface contact with the lower substrate 11 in a region overlapping the switching unit 20 as the heavy component in plan view.

In the present embodiment, one end portion of the bus bar 40, that is, the first end contact portion 42 and the end fixation point set to the first end contact portion 42 overlap the switching unit 20 in plan view. On the other hand, the other end portion of the bus bar 40, that is, the second end contact portion 43 and the end fixation point set thereto are disposed outside the switching unit 20 in plan view. Specifically, the second end contact portion 43 protrudes to the other side in the longitudinal direction X with respect to the switching unit 20, and the end fixation point set in the second end contact portion 43 is disposed close to the terminal block 4.

Lower substrate 11 has a rectangular shape in plan view, and through holes 11a are provided at four corners thereof. A bolt (not shown) for fixing the lower substrate 11 to the casing 2 (see FIG. 1) is inserted into the through-hole 11a. The through hole 11a and the bolt assembled thereto correspond to a unit fixation point for fixing the lower substrate 11 and thus the electronic circuit unit 10 to the casing 2.

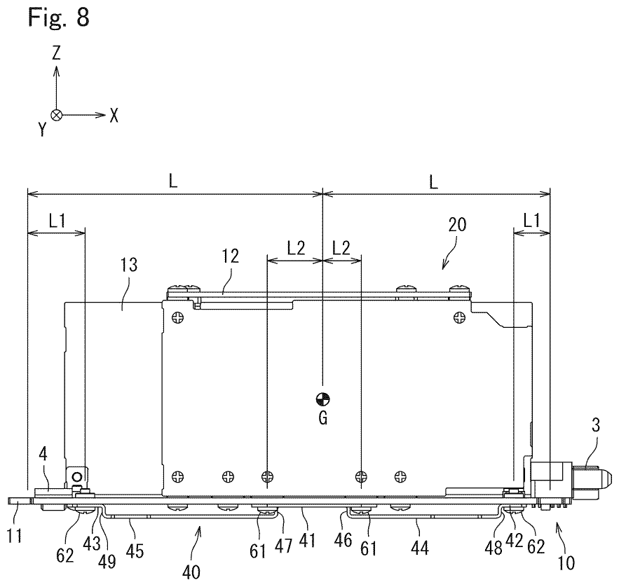

With reference to FIGS. 7 and 8, the end fixation point on the other side (the fixation point set to the second end contact portion 43) is disposed outside the switching unit 20 as a heavy component in plan view and is disposed between the switching unit 20 and the unit fixation point (in particular, a fixation point disposed at a terminal end on the other side in the longitudinal direction X) in the longitudinal direction X.

With reference to FIG. 8, in a side view, the “distance between the unit fixation point and the center of gravity G of the heavy component” is “L”, the “distance between the unit fixation point and the end fixation point adjacent to the unit fixation point in the longitudinal direction” is “L1”, and the “distance between the center of gravity G and the central fixation point” is “L2”. The unit fixation point, the end fixation point, and the central fixation point are arranged such that the sum of the distance L1 and the distance L2 is shorter than the distance L. This applies to both one side and the other side in the longitudinal direction X as viewed from the center of gravity G.

As described above, the electronic circuit unit 10 according to the present embodiment includes the lower substrate 11 having the surface including the upper face and the lower face along the horizontal plane, the heavy component supported by the upper face of the lower substrate 11 and electrically connected to the wiring on the lower substrate 11, and the bus bar 40 attached to the surface of the lower substrate 11, constituting the wiring 30, and arranged to overlap the heavy component in plan view.

As a result, a gravitational load acting on lower substrate 11 from a heavy component is received by bus bar 40. Deformation of the lower substrate 11 and thus deformation of the electronic circuit unit 10 can be suppressed.

The bus bar 40 has a substrate contact portion 41 that is in surface contact with the surface of the lower substrate 11 in a region overlapping a heavy component in plan view. As a result, since the gravitational load easily flows to the bus bar 40 in the substrate contact portion 41, the load shared by the lower substrate 11 is easily reduced.

The substrate contact portion 41 is provided with a conductive member electrically connected to a heavy component. The substrate contact portion 41 overlaps a heavy component in plan view and is in surface contact with the lower substrate 11. By providing the conductive member on the substrate contact portion 41, a structure for electrically connecting the bus bar 40 to a heavy component becomes compact. The conductive member is a metal fastener that fixes the substrate contact portion 41 to the lower substrate 11 and a heavy component. When the substrate contact portion 41 is mechanically fixed to the lower substrate 11, the bus bar 40 is electrically connected to a heavy component. Thus, the assembly operation of the electronic circuit unit 10 is simplified.

Due to the influence of the gravitational load from the heavy component, the lower substrate 11 may be bent and deformed such that the central portion in the longitudinal direction X is directed downward with respect to both ends in the longitudinal direction. Since the bus bar 40 extends along the longitudinal direction of the lower substrate 11, such bending deformation is suppressed.

A pair of end fixation points for fixing the bus bar 40 to the lower substrate 11 is set at both ends of the bus bar 40. The pair of end fixation points is disposed as far as possible along the longitudinal direction of lower substrate 11. The bending deformation of the lower substrate 11 is more easily suppressed.

At least one of one end portion and the other end portion of the bus bar 40 protrudes in the longitudinal direction X with respect to the heavy component in plan view, and at least one of the pair of end fixation points is disposed outside the heavy component in plan view. Since at least one of the pair of end fixation points is disposed outside the heavy component in plan view, bending deformation of the substrate is further easily suppressed.

A casing 2 that supports the lower substrate 11 is further provided, a unit fixation point that fixes the lower substrate 11 to the casing 2 is set at a peripheral edge portion of the lower substrate 11, and at least one of the pair of end fixation points is disposed between a heavy component and the unit fixation point in plan view. Since at least one of the pair of ends of bus bar 40 is fixed to lower substrate 11 between the heavy component and the unit fixation point, bending deformation of lower substrate 11 is more easily suppressed.

Although the embodiment has been described so far, the above configuration is merely an example, and can be appropriately changed within the scope of the present disclosure.

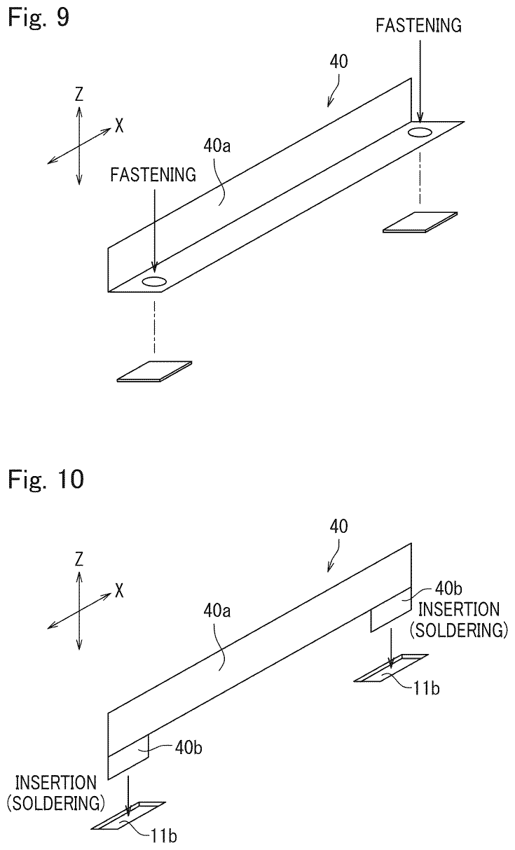

As illustrated in FIG. 9, the bus bar 40 may have a rib 40a protruding upward from the substrate surface and extending in the longitudinal direction X. Due to the presence of the rib 40a, in the bus bar 40, the cross-sectional secondary moment of the bus bar 40 increases against bending deformation in which the central portion in the longitudinal direction X is directed downward with respect to both ends in the longitudinal direction. Therefore, deformation of the lower substrate 11 can be further suppressed.

In the above embodiment and FIG. 9, a fastener is used to fix the substrate of the bus bar 40, but this is an example. As illustrated in FIG. 10, the bus bar 40 may have an insertion piece 40b to be inserted into a slot 11b opened in the substrate. The insertion piece 40b is electrically connected to the wiring pattern printed in the vicinity of the slot 11b by soldering, and the bus bar 40 is fixed to the substrate by this soldering.

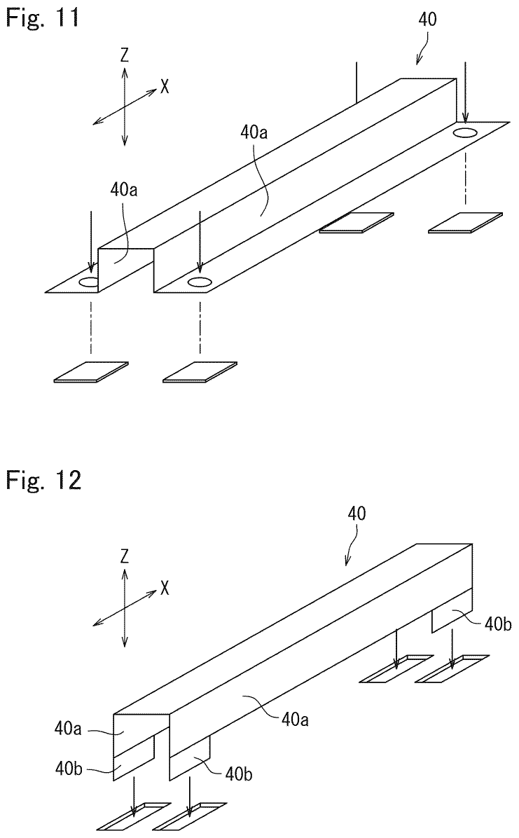

In FIG. 9, the L-shaped bus bar 40 has the rib 40a and is fixed by fastening, but this is an example. As illustrated in FIG. 11, bus bar 40 may have a hat-shaped cross section. In this case, since there are two ribs 40a, deformation of lower substrate 11 is further suppressed.

In FIG. 10, the I-shaped bus bar 40 has the rib 40a and is fixed by soldering, but this is an example. As illustrated in FIG. 12, the bus bar 40 may have a U shape. Also in this case, since the number of ribs 40a is two, deformation of the lower substrate 11 is further suppressed.

Both ends of the bus bar 40 in the longitudinal direction X may protrude in the longitudinal direction X with respect to a heavy component.

The electronic circuit unit is not limited to a converter for charge and discharge control, and can be applied to a circuit unit having other heavy components. The electronic circuit unit is not limited to the components of the battery module, and may be applied to other electronic devices.

The present disclosure may involve the following aspects.

### Aspect 1

An electronic circuit unit comprising:
a substrate having a surface including an upper face and a lower face along the horizontal plane;
a heavy component supported on the upper face of the substrate and electrically connected to a wiring on the substrate; and
a bus bar that is attached to the surface of the substrate, constitutes the wiring, and is disposed so as to overlap the heavy component in a plan view.

### Aspect 2

The electronic circuit unit according to Aspect 1, wherein the bus bar includes a substrate contact portion that is in surface contact with the surface of the substrate in a region overlapping the heavy component in plan view.

### Aspect 3

The electronic circuit unit according to Aspect 2, wherein the substrate contact portion is provided with a conductive member electrically connected to the heavy component.

### Aspect 4

The electronic circuit unit according to Aspect 3, wherein the conductive member is a metal fastener that fixes the substrate contact portion to the substrate and to the heavy component.

### Aspect 5

The electronic circuit unit according to any one of Aspects 1 to 4, wherein the bus bar extends along a longitudinal direction of the substrate.

### Aspect 6

The electronic circuit unit according to Aspect 5, wherein a pair of end fixation points for fixing the bus bar to the substrate is set at both ends of the bus bar.

### Aspect 7

The electronic circuit unit according to Aspect 6, wherein
at least one of one end portion and the other end portion of the bus bar protrudes in the longitudinal direction with respect to the heavy component in plan view, and
at least one of the pair of end fixation points is disposed outside the heavy component in plan view.

### Aspect 8

The electronic circuit unit according to Aspect 7, further comprising a casing that supports the substrate, wherein
a unit fixation point for fixing the substrate to the casing is set at a corner portion of the substrate, and
at least one of the pair of end fixation points is disposed between the heavy component and the unit fixation point in plan view.

### Aspect 9

The electronic circuit unit according to any one of Aspects 5 to 8, wherein the bus bar includes a rib protruding upward or downward from the surface of the substrate and extending in the longitudinal direction.

### Aspect 10

The electronic circuit unit according to any one of Aspects 1 to 9, wherein the bus bar is attached to the lower face of the substrate.

### Aspect 11

A battery module comprising:
the electronic circuit unit according to any one of Aspects 1 to 10; and
a battery cell module connected to the electronic circuit unit.

### Aspect 12

The battery module according to Aspect 11, wherein the electronic circuit unit includes a switching unit that converts a voltage.

What is claimed is:

1. An electronic circuit unit comprising:
a substrate having a surface including an upper face and a lower face along the horizontal plane;
a heavy component supported on the upper face of the substrate and electrically connected to a wiring on the substrate; and
a bus bar that is attached to the surface of the substrate, constitutes the wiring, and is disposed so as to overlap the heavy component in a plan view,
wherein the bus bar extends along a longitudinal direction of the substrate,
a pair of end fixation points for fixing the bus bar to the substrate is set at both ends of the bus bar,
at least one of one end portion and the other end portion of the bus bar protrudes in the longitudinal direction with respect to the heavy component in plan view, and
at least one of the pair of end fixation points is disposed outside the heavy component in plan view.

2. The electronic circuit unit according to claim 1, wherein the bus bar includes a substrate contact portion that is in surface contact with the surface of the substrate in a region overlapping the heavy component in plan view.

3. The electronic circuit unit according to claim 2, wherein the substrate contact portion is provided with a conductive member electrically connected to the heavy component.

4. The electronic circuit unit according to claim 3, wherein the conductive member is a metal fastener that fixes the substrate contact portion to the substrate and to the heavy component.

5. The electronic circuit unit according to claim 1, further comprising a casing that supports the substrate, wherein
a unit fixation point for fixing the substrate to the casing is set at a corner portion of the substrate, and
at least one of the pair of end fixation points is disposed between the heavy component and the unit fixation point in plan view.

6. The electronic circuit unit according to claim 1, wherein the bus bar includes a rib protruding upward or downward from the surface of the substrate and extending in the longitudinal direction.

7. The electronic circuit unit according to claim 1, wherein the bus bar is attached to the lower face of the substrate.

8. A battery module comprising:
an electronic circuit unit; and
a battery cell module connected to the electronic circuit unit,
the electrical circuit unit comprising:
a substrate having a surface including an upper face and a lower face along the horizontal plane;
a heavy component supported on the upper face of the substrate and electrically connected to a wiring on the substrate; and
a bus bar that is attached to the surface of the substrate, constitutes the wiring, and is disposed so as to overlap the heavy component in a plan view,
wherein the bus bar extends along a longitudinal direction of the substrate,
a pair of end fixation points for fixing the bus bar to the substrate is set at both ends of the bus bar,
at least one of one end portion and the other end portion of the bus bar protrudes in the longitudinal direction with respect to the heavy component in plan view, and
at least one of the pair of end fixation points is disposed outside the heavy component in plan view.

9. The battery module according to claim 8, wherein the electronic circuit unit includes a switching unit that converts a voltage.
